(19) United States
(12) Patent Application Publication
(10) Pub. No.: US 2024/0274872 A1
(43) Pub. Date: Aug. 15, 2024

(54) POLYMER ELECTROLYTE COMPRISING CROSSLINKED POLYMER AND ADDITIVE

(71) Applicant: Factorial Inc., Woburn, MA (US)

(72) Inventors: Jia Du, Burlington, MA (US); Dong Ren, Woburn, MA (US); Yiqing Huang, Lexington, MA (US)

(73) Assignee: Factorial Inc., Woburn, MA (US)

(21) Appl. No.: 18/423,443

(22) Filed: Jan. 26, 2024

Related U.S. Application Data
(60) Provisional application No. 63/482,376, filed on Jan. 31, 2023.

(51) Int. Cl. H01M 10/0565; H01M 10/0525

(52) U.S. Cl. CPC H01M 10/0565; H01M 10/0525; H01M 2300/0082

(57) ABSTRACT

A polymer electrolyte includes an additive and a crosslinked polymer with a heterogeneous polymer network synthesized from one or more crosslinkers, wherein at least one crosslinker has three or more polymerizable terminals. In another embodiment, the crosslinked polymer has a polymer network with topological defects. In some embodiments, the additive comprises element F and at least one of elements B and P. In some embodiments, the additive comprises F—B, F—P, F—P—O, F—P=O, or any combinations thereof. In one embodiment, the crosslinked polymer is not over-crosslinked. An electrochemical device with the crosslinked polymer as electrolyte exhibits an improved electrochemical and safety performance.

### CROSS-REFERENCE TO RELATED APPLICATIONS

The present application claims benefit of U.S. Ser. No. 63/482,376, filed Jan. 31, 2023, the entire content of which is incorporated herein by reference into this application.

### FIELD

The present disclosure generally relates to various polymer electrolyte materials suitable for electrochemical devices such as batteries, capacitors, sensors, condensers, electrochromic clements, photoelectric conversion elements, etc.

### BACKGROUND

Battery technologies have transformed significantly over the past five decades. As the field of electrical energy storage continues to grow and be widely applied, lithium-ion batteries (LIB) with increased energy density and more cycling are demanded. Conventional lithium ion battery usually comprises a lithium metal oxide cathode paired with a graphite anode in a liquid electrolyte, which comprises solvent such as carbonate or ether. However, carbonate/ether solvents in the liquid electrolyte are usually highly flammable and thus cause short-circuiting, over-heating, burning or even explosions in case of overcharging or mechanical failure of the battery assembly. As the energy density of LIBs become higher, failure of LIBs with increased energy would cause more serious safety concerns. Therefore, there is a need to address safety issues simultaneously with higher energy density and cycling performance of LIBs.

### SUMMARY

The present disclosure generally relates to various polymer electrolyte materials. The subject matter of the present disclosure involves, in some cases, interrelated products, alternative solutions to a particular problem, and/or a plurality of different uses of one or more systems and/or articles.

In one aspect, the present disclosure is generally directed to a polymer electrolyte containing a crosslinked polymer or copolymer with a heterogencous polymer network synthesized from one or more crosslinkers (alternatively, cross-linkers), wherein at least one crosslinker (alternatively, cross-linker) has three or more polymerizable terminals. In some embodiments, the polymer electrolyte comprises an additive comprising element F and at least one of element B and P and wherein the additive is a different from the electrolyte salt. In some embodiments, the additive comprises F—B, F—P, F—P—O, F—P=O, or any combination thereof. In some embodiments, the polymer electrolyte is synthesized in the presence of a crosslinker with at least four polymerizable terminals. In some embodiments, the polymer electrolyte is synthesized in the presence of a crosslinker with at least five polymerizable terminals.

In some embodiments, the additive includes without limitation LiBF₄, LiPF₆, lithium lithium difluorophosphate (Li₂PO₃F), lithium fluorophosphate (Li₂PO₃F₂), difluoro(bisoxalato)phosphate (LiC₄PO₈F₂), and lithium tetrafluoro oxalato phosphate (LiC₂PO₄F₄), lithium fluoroalkyl-phosphates (Li[PFₓ(CyF₂y+1-2H2)6-x]) (1≤x≤5, 1≤y≤8, and 0≤z≤2y−1), lithium difluoro(oxalato)borate (LiBF₂C₂O₄, LIDFOB) and mixtures thereof. In some embodiments, the lithium fluoroalkyl-phosphates include without limitation lithium bis(trifluoromethyl)-tetrafluorophosphate (Li[PF₄(CF₃)₂]), lithium tris(pentafluorocthyl) trifluorophosphate (Li[PF₃(CF₂CF₃)₃]), lithium tris(nonafluoro-n-propyl) trifluorophosphate (Li[PF₃(CF₂CF₂CF₃)₃]), lithium tris(nonafluoro-n-butyl) trifluorophosphate (Li[PF₃(CF₂CF₂CF₂CF₃)₃]) and a mixture thereof.

In some embodiments, the presence of the additive can increase the number of cycles at a capacity retention at 80% of an electrochemical device including a polymer electrolyte disclosed herein having an additive compared to the number of cycles at a capacity retention at 80% of an electrochemical device including the same polymer electrolyte without the additive by at least 4%, at least 5%, at least 10%, at least 15%, at least 17%, or at least 20%.

In another aspect, the present disclosure is generally directed to an electrochemical device including the polymer electrolyte disclosed herein.

In yet another aspect, the present disclosure is generally directed to a method of making same. In one set of embodiments, the method inculdes mixing an electrolyte salt, an additive comprising clement F and at least one of element B and P, and one or more crosslinkers to form a slurry and curing the slurry by UV curing or by thermal curing, wherein at least one crosslinker has three or more polymerizable terminals. In some embodiments, the slurry is cured after applying the slurry onto a substrate or in situ cured after assembling the slurry into a cell assembly comprising a cathode layer and an anode layer. In some cases, prior to applying the slurry, the cell assembly comprises a cathode layer, an anode layer and a separator. In some embodiments, an in situ curing is conducted after a soaking procedure, which allows the components in the slurry to diffuse into voids of the electrode and separator surface. In some cases, the slurry is formed with a solvent.

In another aspect, the present disclosure encompasses methods of making or using one or more of the embodiments described herein, for example, polymer electrolyte materials.

### DETAILED DESCRIPTION

The present disclosure generally relates to various polymer electrolyte suitable for various electrochemical devices. In some cases, the polymer electrolyte includes an electrolyte salt, an additive and a crosslinked polymer synthesized from one or more crosslinkers, wherein at least one crosslinker has three or more polymerizable terminals. In some embodiments, the polymer electrolyte comprises an additive comprising element F and at least one of element B and P, wherein the additive is different from the electrolyte salt. In some embodiments, the additive comprises F—B, F—P, F—P—O, F—P=O, or any combination thereof. In some embodiments, electrochemical devices having polymer electrolytes disclosed herein have improved cycling performance. Certain aspects include a second polymer, a plasticizer, or a combination thereof. In certain embodiments, the crosslinked polymer refers to a crosslinked copolymer.

In certain embodiments, the crosslinker with three or more polymerizable terminals has a formula as follows:

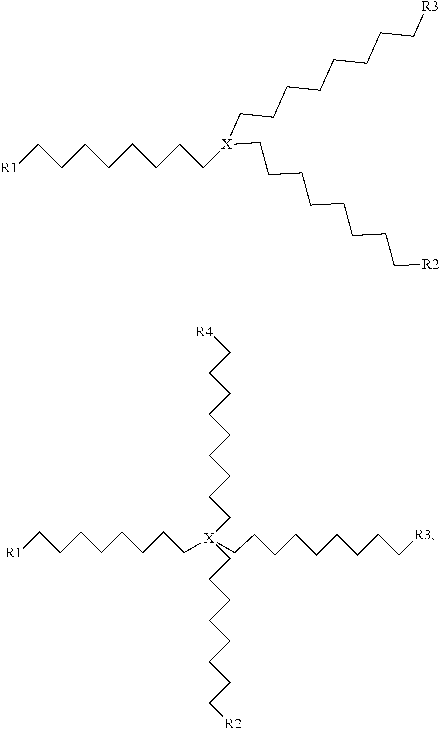

wherein X is C, Si, N, P, B, or a cyclic ring,
R1, R2, and R3 are polymerizable terminals covalently connected to X directly or via a spacer chain or group. R1, R2, R3 and their spacer chains or groups are the same or different from each other.

In certain embodiments, the three or more polymerizable terminals (R1, R2, R3 and R4) are independently selected from the group consisting of C₂₋₂₀ alkenyl, C₂₋₂₀ alkynyl, epoxy, amino, hydroxyl, carboxylic acid, or any substituted form thereof.

In certain embodiments, the crosslinker with three or more polymerizable terminals is a tri-acrylate, tetra-acrylate, modified tri-acrylate, modified tetra-acrylate, silane, siloxane or triazinane-trione (triazine-trione).

In certain embodiments, the crosslinker with three or more terminals has a formula selected from the group consisting of:

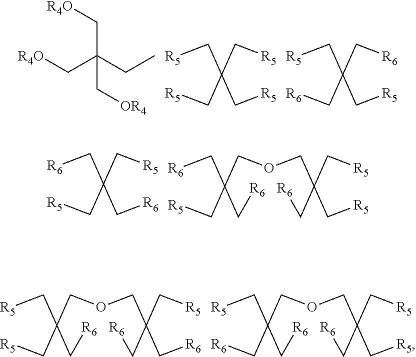

wherein R₄ and R₅ are independently selected from the group consisting of:

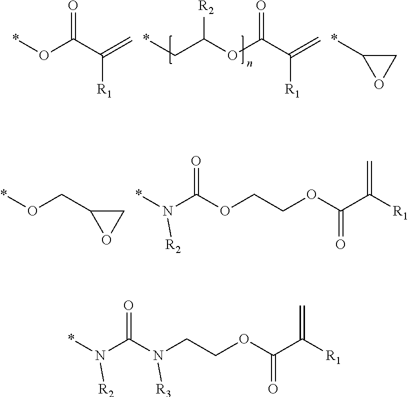

wherein R₁, R₂, R₃, R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.

In certain embodiments, modified tri-acrylates and tetra-acrylates include tri-acrylates and tetra-acrylates with substituted groups such as —CN, —SO₂H, —CO₂H, —CO₂—, F, Cl, Br, or I.

In certain embodiments, the crosslinker with three or more terminals is a silane or siloxane.

In one embodiment, one or more of the crosslinkers or the spacer chains or groups contain a structure including without limitation —O—, —NR^{c}—, —S—, —C(═O)—, —C(═O)O—, —C(═O)NR^{c}—, —C(═O)S—, —OC(—O)O—, —NR^{c}C(═O)O—, —NR^{c}C(═O)NR^{c}—, —S(═O)—, —S(═O)₂—, —OS(═O)₂—, —OS(═O)₂O—, —NRCS(═O)₂—, —NR^{c}S(═O)₂NR^{c}—,-OS(═O)₂NR^{c}—, C₁₋₆alkylenyl, C₂₋₆alkenylenyl, C₂₋₆alkynylenyl, C₆₋₁₄ arylenyl, 5- to 14-membered heteroarylenyl, C₃₋₁₀ carbocyclenyl, or 3- to 10-membered heterocyclenyl, wherein the alkylenyl, alkenylenyl, alkynylenyl, arylenyl, heteroarylenyl, carbocyclenyl, or heterocyclenyl is optionally substituted with halogen, —CN, —NO₂, C₁₋₆alkyl, C₁₋₆haloalkyl, C₁₋₆hydroxyalkyl, C₁₋₆aminoalkyl, C₂₋₆alkenyl, C₂₋₆alkynyl, C₆₋₁₄aryl, 5- to 14-membered heteroaryl, C₃₋₁₀carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NRCS(—O)₂R^{a}, —NRCS(═O)₂R^{a}, —NRCS(═O)₂OR^{b}, —NRCS(═O)₂NR^{c}R^{d}, —NRDC(═O)NR^{c}R^{d}, —NRDC(═O)R^{a}, —NRDC(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein R^{a}, R^{b}, R^{c}, and R^{d} are independently C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₃₋₁₀ carbocyclyl, 3-to 10-membered heterocyclyl, C₆₋₁₄ aryl, or 5- to 14-membered heteroaryl, wherein the alkyl, haloalkyl, hydroxyalkyl, aminoalkyl, alkenyl, alkynyl, carbocyclyl, heterocyclyl, aryl, and heteroaryl is optionally substituted with one or more oxo, halogen, —CN, —OH, —OMe, —NH₂, —C(═O)Me, —C(═O)OH, —C(═O)OMe, C₁₋₆ alkyl, or C₁₋₆ haloalkyl. In certain embodiments, the crosslinker has a formula of:

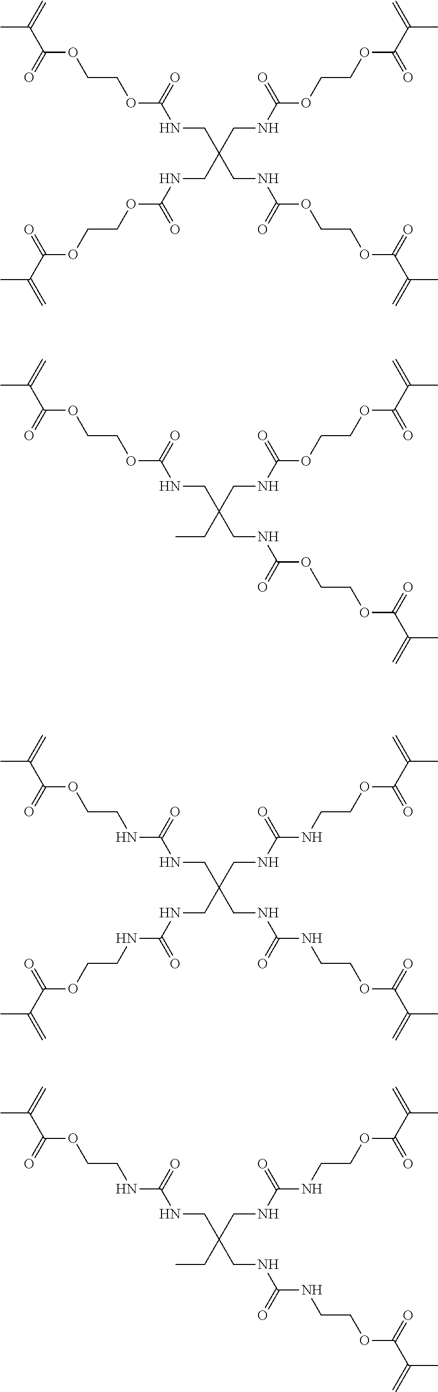

In one embodiment, R^{c} and R^{d}, together with the hetero atom (such as N, O, S, P), form a 3- to 10-membered heterocyclyl, wherein the heterocyclyl is optionally substituted with one or more oxo, halogen, —CN, —OH, —OMe, —NH₂, —C(═O)Me, —C(═O)OH, —C(═O)OMe, C₁₋₆ alkyl, or C₁₋₆ haloalkyl.

In certain embodiments, one of the crosslinkers or the spacer chains or groups comprise a structure of —XC(═O)CR³═C(R⁴)₂, wherein X is independently O or NR^{e}, R^{e} is independently H or C₁₋₆ alkyl, and each R³ and R⁴ is independently H or C₁₋₆ alkyl.

In certain embodiments, one of the crosslinkers comprises one or more functional groups including without limitation:

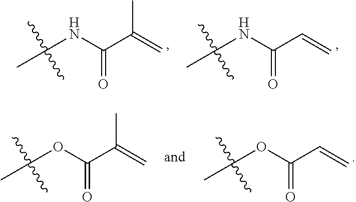

In certain embodiments, the crosslinker with one or more functional groups includes without limitation:

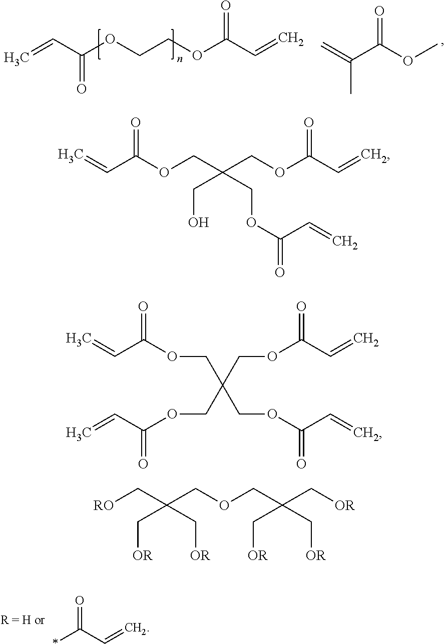

and

In one embodiment, the crosslinker with one or more functional groups is a monomer for ring opening polymerization and has a formular as follows:

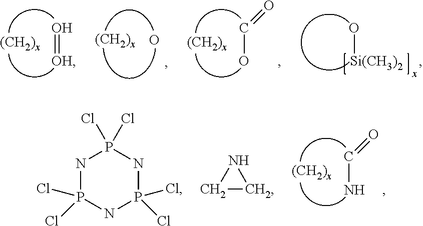

and any substituted form thereof, wherein x is an integer ranging from 1 to 1000.

In one embodiment, the monomer for ring opening polymerization includes:

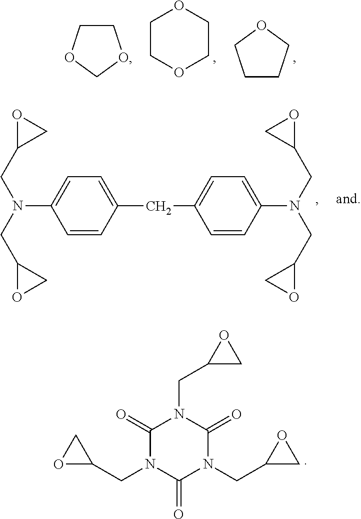

In one embodiment, the monomer for ring opening polymerization comprises an unsubstituted or substituted oxirane ring, oxetane ring, furan ring, aziridine ring, and azetidine ring.

In addition, certain embodiments are directed to compositions for use with polymer electrolytes, batteries, or other electrochemical devices including same, and methods for producing same. In some cases, the incorporation of vinyl and/or allyl functional groups with UV crosslinking or thermal crosslinking can be used to improve various electrochemical performance, especially when the crosslinker has polymerizable terminals, such as vinyl and allyl, in at least three directions of the chemical structure of the crosslinker (i.e. the crosslinker has three polymerizable terminals), the electrochemical performance can be improved more obviously. In certain embodiments, some polymer electrolytes are used to achieve safer, longer-life lithium batteries. In certain embodiments, the electrolytes exhibit better ionic conductivity. These properties benefit charging/discharging rate performances. In addition, the improved decomposition potential of the polymer materials enhances stability of a solid state electrolyte, leading to lithium batteries with a longer-life and/or higher voltage.

In one aspect, the present disclosure is generally directed to an electrochemical cell, such as a battery, including a polymer electrolyte as disclosed herein. In certain embodiments, the battery is an LIB, such as a lithium-ion solid-state battery. The electrochemical cell includes an anode, a cathode, and/or a separator. Many of these are available commercially. In one embodiment, a polymer electrolyte is used as the electrolyte of the electrochemical cell, alone or in combination with other electrolyte materials.

One aspect, for instance, is generally directed to polymer electrolytes including certain polymers that can be used within electrochemical devices, for example, batteries such as LIBs. Such electrochemical devices typically comprise one or more cells, each including an anode, a cathode, and an electrolyte. In comparison to liquid electrolytes, polymer electrolytes may be lightweight and be capable of providing good adhesiveness and processing properties. This may result in safer batteries and other electrochemical devices. In some cases, the polymer electrolyte allows the transport of ions, c.g., without allowing transport of electrons. The polymer electrolyte includes a crosslinked polymer disclosed herein, an electrolyte salt, and an additive comprising clement F and at least one of element B and P. The electrolyte salt may be, for example, a lithium salt, or other salts as disclosed herein. In some embodiments, polymer electrolytes are also referred as polymer solid electrolytes, polymer semi-solid electrolytes, polymer quasi-solid electrolytes or polymer gel electrolytes.

Certain embodiments of the disclosure are generally directed to polymer electrolytes having relatively high ionic conductivity and electrical properties, e.g., decomposition potential. In some cases, for example, a polymer may exhibit improved properties due to the addition of at least three polymerizable terminals at three directions and no poly (ethylene oxide) polymer chain (i.e. free of poly (cthylene oxide) polymer chain) in the crosslinker or crosslinked polymer.

In some embodiments, polymerizable terminals (alternatively groups) include without limitation C₂₋₂₀ alkenyl, C₂₋₂₀ alkynyl, epoxy, amino, hydroxyl, carboxylic acid, or any substituted form thereof. In certain embodiment, they are vinyl and/or allyl.

In addition, in one set of embodiments, the polymerizable terminals or groups such as vinyl and/or allyl may be crosslinked together. For example, such functional groups may be crosslinked using UV light, at an elevated temperature (e.g., between 20 ° C. and 100° C.), in the presence of an initiator, or a combination thereof. In some cases, the incorporation of three polymerizable terminals leads to formation of a heterogeneous polymer network, resulting in improved electrochemical performances, or the like, such as relatively high ionic conductivities, decomposition voltages. In some cases, the incorporation of three polymerizable terminals leads to formation of a disorganized or disordered network, resulting in improved electrochemical performances, or the like, such as relatively high ionic conductivities, decomposition voltages. In some embodiments, a polymerizable terminal may form a crosslinking structure. In some embodiments, a polymerizable terminal may be also termed as a crosslinkable terminal or group.

The crosslink density is generally defined as the number of crosslinks per unit volume in a polymer network. In certain embodiments, the crosslink density is measured, either directly or indirectly, by the numbers of crosslinks per unit volume in the polymer electrolyte after crosslinking (alternatively curing). In certain embodiments, the crosslink density is measured by the numbers of crosslinks from crosslinkers with at least three terminals in at least three directions in the polymer electrolyte after crosslinking. In certain embodiments, the crosslink density is measured by the numbers of crosslinks from crosslinkers with four terminals toward four directions per unit volume in the polymer electrolyte. In certain embodiments, the crosslink density is measured by the numbers of crosslinks from crosslinkers with at least four terminals in at least four directions after crosslinking. In certain embodiments, the crosslink density is indirectly measured by the weight or molar percentage of crosslinkers in the mixture before crosslinking. In certain embodiments, the crosslink density is indirectly measured by the weight or molar percentage of crosslinkers with at least three terminals or crosslinkers with at least four terminals in the mixture before crosslinking. In one embodiment, the polymer electrolyte has a crosslink density corresponding to a crosslinker with a weight percentage of between 0.1% and 30 wt % in the total weight of the polymer electrolyte or the mixture prior to crosslinking.

In some cases, polymer electrolytes such as those described herein provide certain beneficial properties, such as surprisingly high ionic conductivities, compared to other solid electrolytes. For example, the polymer electrolyte may exhibit ionic conductivities of at least 0.01mS/cm, at least 0.05 mS/cm, at least 0.10 mS/cm, at least 0.15 mS/cm, at least 0.20 mS/cm, at least 0.25 mS/cm , at least 0.30 mS/cm, at least 0.35 mS/cm, at least 0.40 mS/cm, at least 0.45 mS/cm, at least 0.50 mS/cm, at least 0.55 mS/cm, at least 0.60 mS/cm, at least 0.65 mS/cm, at least 0.70 mS/cm, at least 0.75 mS/cm, at least 0.80 mS/cm, at least 0.91 mS/cm, at least 0.97 mS/cm, at least 1 mS/cm, at least 1.04 mS/cm, at least 1.05 mS/cm, at least 1.23 mS/cm, at least 1.26 mS/cm, at least 1.31 mS/cm, at least 1.33 mS/cm, at least 1.52 mS/cm, at least 1.80 mS/cm, or at least 2.0 mS/cm. In one embodiment, for example, the polymer electrolyte has ionic conductivity in between 0.01mS/cm and 10 mS/cm at room temperature.

In some cases, the crosslinker has at least three polymerizable terminals, enabling it to crosslink from three or more terminals rather than from two terminals of a linear crosslinker. Without wishing to be bound by any theory, ionic conductivity is improved because the crosslinked polymer network (referred to herein as a “heterogeneous polymer network” or “heterogeneous network”) possesses a unique 3D crosslinking structure which allows and promotes ion transportation. In one embodiment, such unique 3D crosslinking structure is a polymer network with a heterogeneous polymer network, wherein crosslinking points and polymer chains form tunnels and channels as a pathway for movements and transportation of ions. In one embodiment, the tunnels and channels in the heterogeneous crosslinking structure possess spatial configurations which match the hydrodynamic sizes of ions during transportation. In another embodiment, the unique 3D crosslinking structure is a polymer network with topological defects such as loops, dangling chains, multiple connections between two crosslink points, and chain entanglements. In one embodiment, the topological defects of the heterogeneous polymer network form tunnels and channels as a pathway for movements of ions. In one embodiment, the topological defects in the heterogeneous polymer network match the hydrodynamic sizes of ions. In some embodiments, the heterogeneous polymer network refers to a polymer network with a nonuniform structure or composition.

In one embodiment, the heterogeneity of such heterogeneous (alternatively disordered) polymer network is measured in view of or correlated with the weight or molar percentage of the crosslinker with at least three terminals. In one embodiment, the heterogeneity is measured in view of or correlated with the weight or molar percentage of the crosslinker with at least three terminals in consideration of a coefficient indicating spatial contribution of these terminals. For example, heterogeneity may be calculated as k*A, wherein A is the weight or molar percentage and k is the coefficient. In one embodiment, k has a value of 3 and 4 for crosslinkers with 3 and 4 terminals, respectively. In one embodiment, the concentration of the topological defects is measured in view of or correlated with the weight or molar percentage of the crosslinker with at least three terminals in the mixture before crosslinking.

In one embodiment, the crosslinked polymer network does not include poly (ethylene oxide) polymer chain. In one embodiment, multiple crosslinkers can maintain high ionic conductivity of the polymer electrolyte, while minimizing the crosslinker amount.

In one embodiment, the present disclosure also discloses a method of measuring the 3D crosslinking structure in a polymer electrolyte. In one embodiment, the method comprises:
1) placing into a container a polymer electrolyte comprising an electrolyte salt embedded in a 3D crosslinking structure, wherein the container contains a solvent for extracting the electrolyte salt;
2) extracting the electrolyte salt from polymer electrolyte while maintaining the 3D crosslinking structure uncollapsed, resulting in an article free of the electrolyte salt;
3) removing the solvent from the article while maintaining the 3D crosslinking structure uncollapsed, leading to a dried article; and
4) measuring specific surface area such as BET and pore size distribution of the dried article based on a nitrogen adsorption method, thereby obtaining the 3D crosslinking structure comprising the specific surface area and pore size distribution.

In one embodiment, the container for extraction is kept at a temperature to maintain the 3D crosslink structure unfolded. In one embodiment, the temperature is at least 20° C. lower than the glass transition temperature of the crosslinked polymer, which may be measured by differential scanning calorimetry (DSC), dynamic mechanical analysis, or any other equivalent techniques. In one embodiment, the solvent is pre-selected so that it can dissolve the electrolyte salt but not affect the morphology of the 3D crosslinked polymer.

In one embodiment, the present disclosure provides a polymer electrolyte comprising an electrolyte salt and a crosslinked polymer network synthesized from one or more crosslinkers, wherein at least one crosslinker has three or more polymerizable terminals.

In one embodiment, the present disclosure provides a polymer electrolyte comprising an electrolyte salt and a crosslinked polymer with a heterogeneous polymer network synthesized from one or more crosslinkers, wherein at least one crosslinker has three or more polymerizable terminals. In some embodiments, the polymer electrolyte comprises an additive comprising clement F and at least one of clement B and P. Such as an additive is different from the electrolyte salt. In some embodiments, the additive comprises F—B, F—P, F—P=O, F—P=O, or any combination thereof.

In some embodiments, the additive is selected from the group consisting of LiBF₄, LiPF₆, lithium fluorophosphate (Li₂PO₃F), lithium difluorophosphate (Li₂PO₂F₂), lithium difluoro(bisoxalato)phosphate (LiC₄PO₈F₂), and lithium tetrafluoro oxalato phosphate (LiC₂PO₄F₄), lithium fluoroalkyl-phosphates (Li[PFₓ(C_{y}F_{2y+1-z}H_{z})₆₋ₓ]) (x, y and z are integer, 1≤x≤5, 1≤y≤8, and 0≤z≤2y=1), and lithium difluoro(oxalato)borate (Li[BF₂(C₂O₄)], LiDFOB), and combinations thereof. In some embodiments, the additive also includes zinc fluorophosphate (ZnPO₃F), zinc difluorophosphate (ZnPO₂F₂), potassium fluorophosphate (K₂PO₃F), potassium difluorophosphate (K₂PO₂F₂), sodium fluorophosphate (Na₂PO₃F), and sodium difluorophosphate (Na₂PO₂F₂). In some embodiments, the additive comprises a cation and an anion. In some embodiment, the cation is selected from the group consisting of Li⁺, Na⁺, K⁺, Cs⁺, NH₄⁺, Ag⁺, Zn²⁺ or a combination thereof. In some embodiments, the anion comprises F—B, F—P, F—P=O, F—P=O, or a combination thereof. In some embodiments, the anion is selected from BF₄⁻, PF₆⁻, [PO₃F]²⁻, [PO₂F₂]²⁻, [C₄PO₈F₂]⁻, [C₂PO₄F₄]⁻, [PFₓ(C_{y}F_{2y+1-z}H_{z})₆₋ₓ]⁻ (x, y and z are integer, 1≤x≤5, 1≤y≤8, and 0≤z≤2y−1), [BF₂(C₂O₄)]⁻ or a combination thereof.

In some embodiments, the additive has a concentration in a range from 0.01 wt % to 2 wt % in the polymer electrolyte or in the mixture prior to crosslinking. In some embodiments, the additive has a concentration in a range from 0.001 wt % to 2 wt %, from 0.002 wt % to 2 wt %, from 0.005 wt % to 2 wt %, from 0.01 wt % to 2 wt %, 0.02 wt % to 2 wt %, from 0.05 wt % to 2 wt %, from 0.1 wt % to 2 wt %, from 0.001 wt % to 1 wt %, from 0.002 wt % to 1 wt %, from 0.005 wt % to 1 wt %, from 0.01 wt % to 1 wt %, from 0.02 wt % to 1 wt %, or from 0.05 wt % to 1 wt % in the polymer electrolyte or in the mixture prior to crosslinking as disclosed herein. In some embodiments, the additive has a concentration in a range from 0.01 wt % to 5.0 wt % in the polymer electrolyte or in the mixture prior to crosslinking. In some embodiments, the additive has a concentration in a range from 0.01 wt % to 5 wt %, from 0.02 wt % to 5 wt %, from 0.05 wt % to 5 wt %, from 0.1 wt % to 5 wt %, 0.2 wt % to 5 wt %, from 0.5 wt % to 5 wt %, from 1 wt % to 5 wt %, or from 2 wt % to 5 wt % % in the polymer electrolyte or in the mixture prior to crosslinking. In certain embodiments, the mixture prior to crosslinking and the polymer electrolyte after crosslinking have the same or different weight, which depends on the nature of the crosslinking. There would be no or minor weight change for crosslinkers that are crosslinked via a radical polymerization or similar mechanism.

In one embodiment, the crosslinker with three or more polymerizable terminals has a concentration in a range from 0.1 wt % to 20 wt % in the polymer electrolyte or in the mixture prior to crosslinking. In one embodiment, the one or more crosslinkers have a concentration in a range from 0.1 wt % to 30 wt % in the polymer electrolyte or in the mixture prior to crosslinking. In some embodiments, the crosslinker has a concentration in a range from 0.1 wt % to 20 wt %, from 0.2 wt % to 20 wt %, from 0.5 wt % to 20 wt %, from 1.0 wt % to 20 wt %, from 2 wt % to 20 wt %, from 5 wt % to 20 wt %, from 10 wt % to 20 wt %, from 0.1 wt % to 10 wt %, from 0.2 wt % to 10 wt %, from 0.5 wt % to 10 wt %, from 1.0 wt % to 10 wt %, from 2 wt % to 10 wt %, from 5 wt % to 10 wt %, from 0.1 wt % to 5 wt %, from 0.2 wt % to 5 wt %, from 0.5 wt % to 5 wt %, from 1.0 wt % to 5 wt %, or from 2 wt % to 5 wt % in the polymer electrolyte or in the mixture prior to crosslinking.

In one embodiment, at least one of the one or more crosslinkers has an electron-donating group, which promotes ion transport in the electrolyte.

In one embodiment, the electron-donating group is an amide.

In one embodiment, the crosslinker with three or more polymerizable terminals is a silane or siloxane selected from the group consisting of:

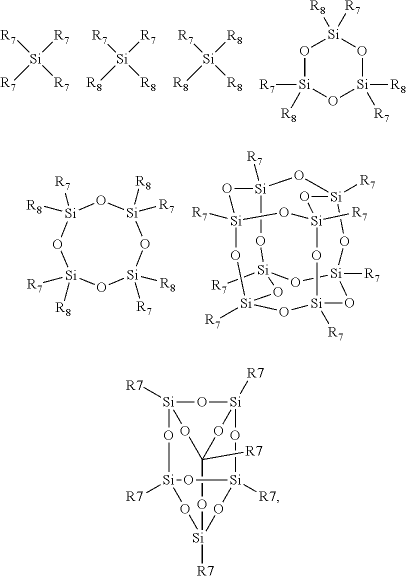

wherein R₇ is independently selected from the group consisting of:

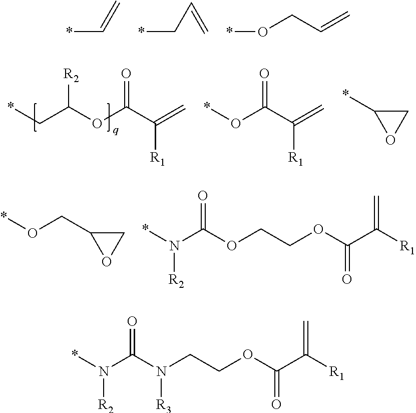

wherein R₁, R₂ and R₃ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein q is an integer between 0 and 50,000,
wherein R₈ is independently selected from the group consisting of:

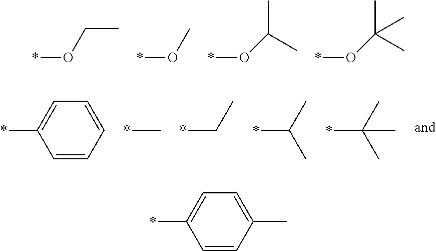

* indicates a point of attachment.

In one embodiment, the crosslinker with three or more polymerizable terminals has a formula:

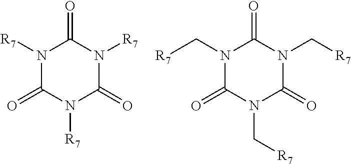

wherein R₇ is independently selected from the group consisting of:

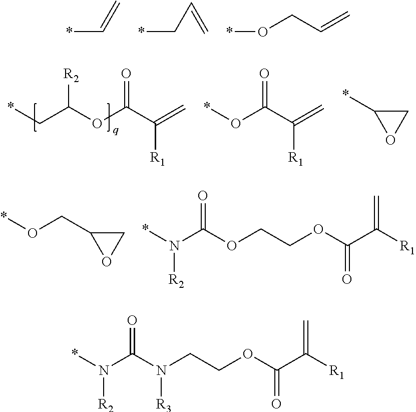

wherein R₁, R₂ and R₃ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein q is an integer between 0 and 50,000 and * indicates a point of attachment.

In some embodiments, the crosslinker with three or more polymerizable terminals include one or more of the following:

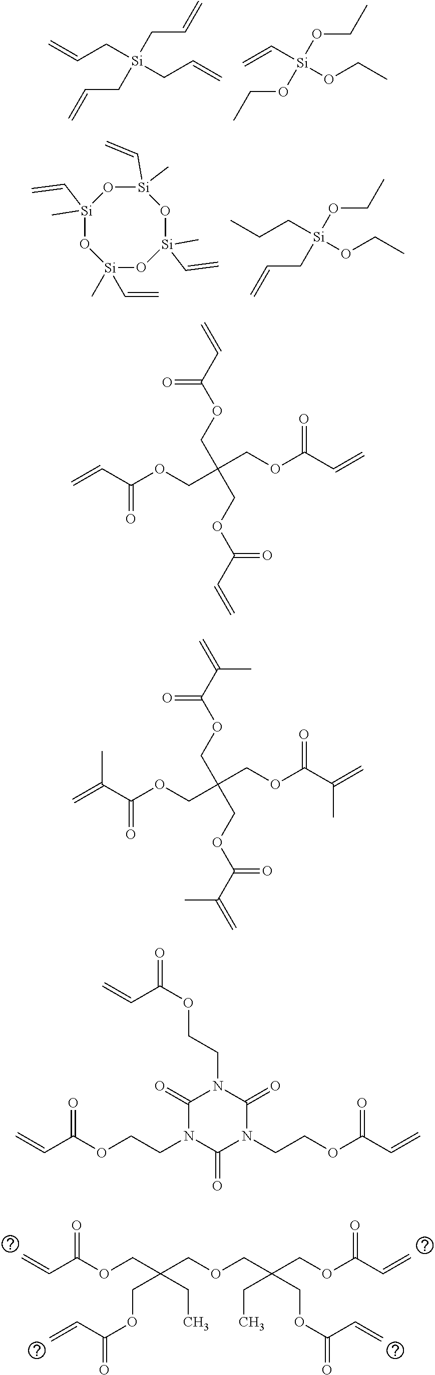

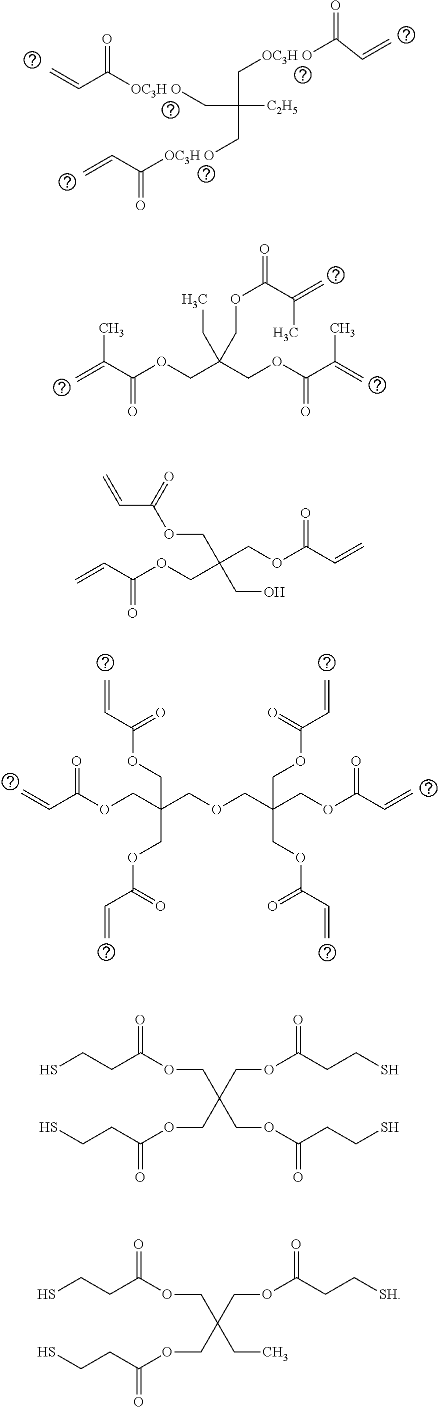

In some embodiment, the crosslinker with no more than 2 terminals includes 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=700), triethylene glycol dimethacrylate (TEGDMA), diurethane dimethacrylate or a combination thereof.

In some embodiments, certain crosslinker such triethoxyvinylsilane and allyltriethoxysilane may be categorized as crosslinker with no more than two polymerizable terminals under certain conditions while categorized as crosslinker with three or more polymerizable terminals under other conditions. For example, alkoxy groups of alkoxysilanes may form crosslinking structure via hydrolysis and condensation. Under a condition for radical polymerization only, triethoxyvinylsilane and allyltriethoxysilane are categorized as crosslinkers with one polymerizable terminal. Under a condition for hydrolysis and condensation, tricthoxyvinylsilane and allyltriethoxysilane are crosslinkers with three polymerizable terminals. Under a condition for radical polymerization, hydrolysis and condensation, either via one step or multiple steps, they are categorized as crosslinkers with four terminals.

In certain embodiments, crosslinkers with three or more polymerizable terminals also include modified silica with polymerizable terminals immobilized on its surface. Non-limiting specific crosslinkers include AEROSIL® 380 (Evoniks), AEROSIL® 711 (Evoniks), and AEROSIL® R 7200 (Evoniks).

In one embodiment, the electrolyte salt comprises a lithium salt. In certain embodiments, the lithium salt is selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), bis-trifluoromethyl sulfonylimide lithium (LIN(CF₃SO₂)₂), lithium bis(oxalato)borate (LiBOB), lithium nitrate (LiNO₃), lithium fluoroalkyl-phosphates (Li[PFₓ(C_{y}F_{2y+1-z}H_{z})₆₋ₓ]) (1≤x≤5, 1≤y≤8, and 0≤z≤2y−1), lithium bisperfluoro-ethysulfonylimide (LiBETI), lithium bis(trifluoromethanesulphonyl) imide, lithium bis(fuorosulphonyl)imide, lithium trifluoromethanesulfonimide (LiTFSI), lithium bis(fluorosulfonyl)imide (LiFSI), lithium difluoro(oxalato)borate (LiDFOB), lithium perchlorate (LiClO₄), LIC(CF₃SO₂)₃, LIF, LiCl, LiBr, LiI, Li₂SO_{4,} Li₃PO₄, Li₂CO₃, LiOH, lithium acetate, lithium trifluoromethyl acetate, lithium oxalate and a mixture thereof.

In one embodiment, the electrolyte salt has a concentration in a range from 10 wt % to 90 wt %. In some embodiments, the electrolyte salt has a concentration in a range from 10 wt % to 85 wt %, from 10 wt % to 80 wt %, from 10 wt % to 75 wt %, from 10 wt % to 70 wt %, from 10 wt % to 65 wt %, from 10 wt % to 60 wt %, from 10 wt % to 55 wt %, from 10 wt % to 50 wt %, from 10 wt % to 45 wt %, from 10 wt % to 40 wt %, 10 wt % to 35 wt %, 10 wt % to 30 wt % or from 10 wt % to 25 wt % in the polymer electrolyte or in the mixture prior to crosslinking. In some embodiments, the electrolyte salt has a concentration in a range from 25 wt % to 90 wt %, from 30 wt % to 90 wt %, from 35 wt % to 90 wt %, from 40 wt % to 90 wt %, from 45 wt % to 90 wt %, from 50 wt % to 90 wt %, from 50 wt % to 90 wt %, from 55 wt % to 90 wt %, from 60 wt % to 90 wt %, from 65 wt % to 90 wt %, or from 70 wt % to 90 wt % in the polymer electrolyte or in the mixture prior to crosslinking .

In one embodiment, the one or more crosslinkers are crosslinked in the presence of an initiator, under UV light, or at an elevated temperature.

In one embodiment, the present disclosure provides an electrochemical device comprising the electrolyte as described herein.

In one embodiment, the electrochemical device is anode-free or comprises an anode.

In one embodiment, the anode is a carbon anode, Li anode, Si anode, alloy anode, Li₄Ti₅O₁₂, or made from conversion anode materials, wherein the carbon anode comprises graphite, soft carbon, hard carbon, or combinations of thereof, the Li anode comprises Li metal foil, Li metal on Cu, Ni, or stainless steel, the Si anode comprises Si, Si/Carbon composite, SiOₓ (0≤x<2), SiOₓ (0≤x<2)/carbon composite or a combination thereof, the Alloy anode comprises Sn, SnO₂, Sb, Al, Mg, Bi, In, As, Zn, Ga, B, or a combination thereof, and the conversion anode materials comprise MₐX_{b}, M is Mn, Fc, Co, Ni, or Cu, X is O, S, Se, F, N, or P, a and b arc respectively 1 to 4.

In one embodiment, the electrochemical device comprises a cathode comprising an electroactive material including lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

In some embodiments, addition of a second crosslinker to the electrolyte system can lead to a more heterogeneous polymer network with more topological defects, which would likely facilitate ion transport, as ions can move more freely in the electrolyte.

In some embodiments, polymer electrolytes such as those described herein may provide relatively high decomposition voltages. Polymer electrolytes with relatively high decomposition voltages may be particularly useful, for example, in applications where higher voltages arc required. In certain cases, the decomposition voltage of the polymer electrolyte may be at least 0.1 V, at least 0.2 V, at least 0.3 V, at least 0.4 V, at least 0.5 V, at least 0.6 V, at least 0.7 V, at least 0.8 V, at least 0.9 V, at least 1 V, at least 1.5 V, at least 2 V, at least 2.5 V, at least 3 V, at least 3.5 V, at least 3.8 V, at least 4 V, at least 4.3 V, at least 4.5 V, at least 4.8 V, at least 5V, at least 5.3V, at least 5.5 V, or at least 6 V. Decomposition voltages can be tested using standard techniques known to those of ordinary skill in the art, such as cyclic voltammetry. Without wishing to be bound by any theory, the crosslinker without poly (ethylene oxide) chain is not easily oxidized. A polymer electrolyte from such crosslinker can resist decomposition and possess a relatively higher decomposition voltage.

In some embodiments, the polymer electrolyte may include a second additive for improving processability, and/or controlling the ionic conductivity and mechanical strength. For example, the second additive may be a polymer, a small molecule (i.e., having a molecular weight of less than 1 kDa), a nitrile, an oligoether, cyclic carbonate, ionic liquids, or the like. Examples of the oligoether includes diethyl ether, 2-ethoxyethanol, dimethoxy methane, dimethoxy ethane, 1,2-diethoxyethane, 1,1-dicthoxyethanc, 1,1-dipropoxy-cthanc, 1,2-dipropoxy-cthane, diethylene glycol, 2-(2-cthoxyethoxy)cthanol, diethylene glycol dimethyl ether, dicthylene glycol dicthyl ether, diethylene glycol dibutyl ether, tricthylene glycol, tri(ethylene glycol) monomethyl ether, tri(cthylene glycol) monocthyl ether, tri(ethylene glycol) monobutyl ether, tricthylene glycol dimethyl ether, triethylene glycol diethyl ether, diethylene glycol dibutyl ether, tetraethylene glycol, tetra(cthylene glycol) monomethyl ether, tetra(cthylene glycol) monocthyl ether, tetra(cthylene glycol) monobutyl ether, tetraethylene glycol dimethyl ether, tetracthylene glycol diethyl ether, tetracthylene glycol dibutyl ether, or the like. Non-limiting examples of potentially suitable second additives include ethylene carbonate, diethyle carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, poly(ethylene oxide), or the like. In some case, the second additives may act as solvent. In some other case, the second additives may act as plasticizer.

In some embodiments, the second additive can be present at a weight percentage of at least 1 wt %, at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, or at least 85 wt %, based on a total weight of the polymer electrolyte.

The electrolyte salt may include a lithium salt. Specific non-limiting examples of lithium salts include lithium perchlorate (LiClO₄), lithium hexafluorophosphate (LiPF₆), lithiumborofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate(LiNO₃), lithium fluoroalkyl-phosphates (Li[PFₓ(C_{y}F_{2y+1-z}H_{z})₆₋ₓ]) (1≤x≤5, 1≤y≤8, and 0≤z≤2y−1), lithium bisperfluoro-ethysulfo-nylimide (LiBETI), lithium bis(trifluoromethanesulphonyl) imide, lithium bis(fluorosulphonyl)imide, lithium trifluoromethanesulfonimide (LiTFSI), lithium bis(fluorosulfonyl)imide (LiFSI), LiC(CF₃SO₂)₃, LIF, LiCl, LiBr, LiI, Li₂SO_{4,} Li₃PO₄, Li₂CO₃, LiOH, lithium acetate, lithium trifluoromethyl acetate, lithium oxalate, and a combination thereof.

In some embodiments, the electrolyte salt has a mole fraction of at least 0.5 M, at least 1 M, at least 1.5 M, at least 2 M, at least 2.5 M, at least 3 M, at least 3.5 M, at least 4 M, at least 4.5 M, at least 5 M, at least 5.5 M, at least 6 M, at least 6.5 M, at least 7 M, at least 7.5 M, at least 8 M, at least 8.5 M, at least 9 M, at least 9.5 M, at least 10 M and/or no more than 0.5 M, no more than 1 M, no more than 1.5 M, no more than 2 M, no more than 2.5 M, no more than 3 M, no more than 3.5 M, no more than 4 M, no more than 4.5 M, no more than 5 M, no more than 5.5 M, no more than 6 M, no more than 6.5 M, no more than 7 M, no more than 7.5 M, no more than 8 M, no more than 8.5 M, no more than 9 M, no more than 9.5 M, no more than 10 M.

In some embodiments, an initiator may be present. Specific non-limiting examples of initiators include 2,2′-azobis(2-methylpropionitrile), benzoyl peroxide, cumene hydroperoxide, dicumyl peroxide, tert-butyl hydroperoxide, di-tert-butyl peroxide, 2,2′-azobis[2-(2-imidazolinc-2-yl)propane] dihydrochloride, ammonium persulfate, anisoin, anthraquinone, benzophenone, benzoin methyl ether, 2-isopropylthioxanthone, 9,10-phenanthrenequinone, 3′-hydroxyacetophenone, 3,3′,4,4′-benzophenonetetreacarboxylic dianhydride, 2-benzoylbenzoic acid, (+)-camphorquinonc, 2-ethylanthraquinone, 2-methylbenzophenone, 4-hydroxybenzophenone, 2-hydroxy-2-methylpropiophenone, benzoin isobutyl ether, 4,4′-bis(dimethylamino)benzophenone, 4,4′-dihydroxybenzophenone, 4-benzoyl 4′-methyldiphenyl sulfide, ferrocene, dibenzosuberenone, benzoin ethyl ether, benzil, methyl benzoylformate, 4-benzoylbenzoic acid, or others alike. In some cases, the initiator has a weight percentage (alternatively fraction) between 0.01 wt % and 5 wt %, or other suitable mole fractions to initiate crosslinking, based on a total weight of the polymer electrolyte. The present disclosure discovered that the weight fraction of initiator is preferably no more than a certain threshold value to avoid over-crosslinking and/or retain the heterogeneity of the heterogeneous polymer network. In one embodiment, the weight percentage of the initiator is no more than 5.0 wt %, no more than 4.0 wt %, no more than 3.0 wt %, no more than 2.0 wt %, or no more than 1.0 wt %. In one embodiment, the weight fraction is no more than 1.0%, no more than 0.8 wt %, no more than 0.6 wt %, no more than 0.4 wt %, no more than 0.2 wt %, no more than 0.1 wt %, or no more than 0.05 wt %.

In certain cases, a crosslinker, an additive, an electrolyte salt and optionally a second additive may cach present within the polymer electrolyte at any suitable concentration. In addition, one or more than one of these may be present, e.g., there may be more than one crosslinker, and/or more than one plasticizer, and/or more than one electrolyte salt. In certain embodiments, the polymer electrolyte comprises a polymer which does not form any chemical bonds with the polymer network and is physically distributed within the polymer electrolyte. In certain embodiments, the mixture for synthesizing the polymer electrolyte comprises a first crosslinker with at least three polymerizable terminals and a second crosslinker with at least one polymerizable terminal. In certain embodiments, the first and second crosslinker forms two separate polymer networks, for example polymer network A and polymer network B wherein no chemical bonds between these two networks. In certain embodiments, the first and second crosslinker reacts with each other and forms a single polymer network or copolymer network.

In one set of embodiments, the crosslinker(s) may be present at a weight percentage of at least 0.01 wt %, at least 0.02 wt %, at least 0.027 wt %, at least 0.03 wt %, at least 0.05 wt %, at least 0.1 wt %, at least 0.11 wt %, at least 0.12 wt %, at least 0.13 wt %, at least 0.15 wt %, at least 0.2 wt %, at least 0.3 wt %, at least 0.5 wt %, at least 1.0 wt %, at least 1.5 wt %, at least 2.0 wt %, at least 2.5 wt %, at least 3 wt %, at least 3.5 wt %, at least 4 wt %, at least 4.5 wt %, at least 5.0 wt %, at least 6.0 wt %, at least 7.0 wt %, at least 8.0 wt %, at least 9.0 wt %, at least 10 wt %, at least 11 wt %, at least 12 wt %, at least 13 wt %, at least 14 wt %, at least 15 wt %, at least 30 wt %, at least 40 wt %, at least 50 wt %, and/or no more than 0.01 wt %, no more than 0.02 wt %, no more than 0.027 wt %, no more than 0.03 wt %, no more than 0.05 wt %, no more than 0.1 wt %, no more than 0.11 wt %, no more than 0.12 wt %, no more than 0.13 wt %, no more than 0.15 wt %, no more than 0.2 wt %, no more than 0.3 wt %, no more than 0.5 wt %, no more than 1.0 wt %, no more than 1.5 wt %, no more than 2.0 wt %, no more than 2.5 wt %, no more than 3 wt %, no more than 3.5 wt %, no more than 4 wt %, no more than 4.5 wt %, no more than 5.0 wt %, no more than 6.0 wt %, no more than 8.0 wt %, no more than 9.0 wt %, no more than 10 wt %, no more than 12 wt %, no more than 15 wt %, no more than 20 wt %, no more than 30 wt %, no more than 40 wt %, no more than 50 wt %, based on the total weight of the polymer electrolyte or the mixture prior to crosslinking.

In certain embodiments, the weight ratio of the crosslinker(s) based on total weight of electrolyte is no more than 30 wt %, no more than 20 wt %, no more than 10 wt %, no more than 8%, no more than 6%, no more than 5%, no more than 4%, or no more than 3% to prevent from over-crosslinking. Without wishing to be bound by any theory, an electrolyte comprising over-crosslinked polymer exhibits poor processability and ionic conductivity probably due to the rigid polymer network and restricted ion transport therein. The present disclosure also discovered that a film of polymer electrolyte became more rigid when the weight ratio of crosslinker(s) exceeded a certain threshold weight percentage or ratio which may be probably due to the over-crosslinking structure. In return, such over-crosslinking and rigid structure significantly deteriorated the electrochemical performance, especially cycling performance. In certain embodiments, the threshold weight ratio of the crosslinker(s) related to over-crosslinking may depend on molecular weight, number of polymerizable terminals, density of electrolyte, etc. and subject to further adjustment as necessary.

In certain embodiments, the weight ratio of the crosslinker with at least three terminals based on total weight of polymer electrolyte is no more than 20 wt %, no more than 10 wt %, no more than 8%, no more than 6%, no more than 5%, no more than 4%, no more than 3%, no more than 2% or no more than 1.5%. In certain embodiments, the threshold weight ratio of the crosslinker with at least three terminals related to over-crosslinking may depend on its molecular weight, number of polymerizable terminals, density of electrolyte, etc. and subject to further adjustment as necessary.

In certain embodiments, the weight ratio of the crosslinker(s) based on total weight of electrolyte may be no less than 2%, no less than 1%, no less than 0.8%, no less than 0.5%, or no less than 0.1%. Without wishing to be bound by any theory, the minimum amount of crosslinker(s) is to keep the electrolyte in a solid rather than liquid form to ensure the processibility and stability.

As for crosslinked polymers synthesized from two crosslinkers, the weight ratio of these two crosslinkers ranges from 10:1 to 1:1 according to some embodiments of the present disclosure. In some embodiments, the molar ratio of two crosslinkers ranges from 10:1 to 1:1.

In certain embodiments, the weight ratio of the crosslinkers to the electrolyte salt is from about 50:1 to about 10:1. In certain embodiments, the weight ratio of the crosslinkers to the electrolyte salt is from about 10:1 to about 1:1.

In certain embodiments, the crosslinker or crosslinkers have a molecular weight of about 2 kDa or less, about 1.9 kDa or less, about 1.8 kDa or less, about 1.7 kDa or less, about 1.6 kDa or less, about 1.5 kDa or less, about 1.4 kDa or less, about 1.3 kDa or less, about 1.2 kDa or less, about 1.1 kDa or less, about 1.0 kDa or less, about 0.9 kDa or less, about 0.8 kDa or less, about 0.7 kDa or less, or about 0.6 kDa or less.

Combinations of any of one or more of the above ranges and intervals are also possible. For example, a crosslinker (including more than one crosslinker) has a weight fraction between 1 wt % and 50 wt % (that is, the total crosslinker does not exceed 50 wt %), an electrolyte salt (including more than one electrolyte salt) has a mole fraction between 1.0 M and 4 M. Without wishing to be bound by any theory, if the crosslinker concentration is too low, the polymer electrolyte may be relatively soft, which could be hard to handle; however, if the crosslinker concentration is too high, the polymer electrolyte may be very tough, casy to break during handling, and may not provide good adhesion.

Certain aspects of the present disclosure are generally directed to systems and methods for producing any of the polymer electrolytes discussed herein. For example, in one set of embodiments, a polymer may be produced by reacting various crosslinkers together.

In one set of embodiments, the crosslinker may be mixed with a solvent and electrolyte salts to form a slurry, which can be cured to form a polymer electrolyte. In addition, in some cases, multiple crosslinkers may be present in the slurry, which may be added to the slurry sequentially, simultaneously, etc. The crosslinkers may each independently be crosslinkers as described herein, and/or other suitable crosslinkers.

In some embodiments, the slurry may be cured to form a film, such as a solid-state film. In some embodiments, the film has a thickness of between 100 nm and 500 um. For instance, the mixture can be formed into a film by curing, for example, using UV light, thermoforming, exposure to elevated temperatures, or the like. For example, curing may be induced using exposure to UV light for at least 3 min, at least 5 min, at least 10 min, at least 15 min, etc., and/or by exposure to temperatures of at least 20° C., at least 30° C., at least 40° C., at least 50° C., at least 60° C., at least 70° C., at least 80° C., at least 90° C., at least 100° C.,at least 110° C., at least 120° C. , at least 130° C., at least 140° C., at least 150° C., etc. As an example, a slurry may be coated or positioned on a surface and/or within a mold and exposed to UV light to cure.

In some cases, during the curing process, at least some of the crosslinkers may also crosslink, e.g., as discussed herein, which in some cases may improve various electrochemical performance. For example, exposure to UV light may facilitate the crosslinking process.

The present disclosure generally relates to a device with various polymer electrolytes mentioned above. The device may be a battery, an LIB or a lithium-ion solid-state battery. The battery may be configured for applications such as, portable applications, transportation applications, stationary energy storage applications, and the like. Non-limiting examples of the ion-conducing batteries include lithium-ion conducting batteries, and the like. The device may also be a battery comprising one or more lithium ions electrochemical cells.

In various examples, a battery includes an electrolyte of the present disclosure, an anode, and a cathode with an electroactive material.

In various examples, the anode includes carbon anode, Li anode, Si anode, Alloy anode, and/or conversion anode materials. The carbon anode includes graphite, soft carbon, hard carbon, or combinations of thereof. The Li anode includes Li metal foil, Li metal on Cu (or on other current collectors, such as stainless steel, Ni). The Si anode includes Si, Si/Carbon composite anode, SiOₓ (0≤x<2), SiOₓ((0≤x<2)/carbon composite anode. The Alloy anode includes Sn, SnO₂, Sb, Al, Mg, Bi, In, As, Zn, Ga, B. In various examples, a battery is anode free (only includes current collector)

The conversion anode materials include MₐX_{b}, M is Mn, Fe, Co, Ni, Cu, and X is O, S, Se, F, N, P, etc. In addition, a and b are respectively 1 to 4.

In various examples, other possible anode materials include Li₄Ti₅O₁₂.

In various examples, the electroactive material includes lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

In addition, in some embodiments, the electrochemical device has a capacity retention of 90.7% to 100% after 87 cycles using a discharging current at a rate of 0.5C at 25° C. or has a capacity retention of at least 99.2% after 73 cycles using a discharging current at a rate of 0.5C at 25° C.

In addition, in some embodiments, the electrochemical device has a capacity retention of at least 41%, at least 46%, at least 51%, at least 56%, at least 62%, at least 67%, at least 72%, at least 77%, at least 82%, at least 87%, at least 90.7%, at least 92%, at least 95%, at least 97%, at least 99.2%, at least 99.3%, at least 99.5% or the like when a discharging current rate of 0.5 C being used at 25° C.

In addition, in some embodiments, the electrochemical device has an exothermic reaction of at least 130° C., at least 140° C., at least 150° C., at least 160° C., at least 170° C., at least 180° C., at least 190° C., at least 200° C., at least 210° C., at least 220° C., at least 230° C., at least 240° C., or at least 250° C.

In addition, the present disclosure generally relates to a method of making an article (such as the polymer electrolyte as disclosed herein). The method includes a step of mixing one or more crosslinkers to form a slurry and a step of curing the slurry by UV curing or by thermal curing to form a polymer electrolyte, wherein at least one crosslinker has three or more polymerizable terminals.

In addition, in some embodiments, the method further comprising adding the slurry to a mold prior to curing the slurry, coating the slurry on a surface prior to curing the slurry. In some embodiments, only one crosslinker is added. In some embodiments, multiple crosslinkers are added simultaneously or sequentially. In some alternative embodiments, additional crosslinkers (such as a second and/or third crosslinkers) may be subsequently added to the slurry prior to curing the slurry. In some embodiments, the subsequently added crosslinker may same as or different from the first added crosslinker. When multiple crosslinkers are used, the 2^{nd} crosslinker can be a monomer that can lead to a linear polymer, a branched polymer, or a crosslinked polymer.

In some embodiments, the slurry can be cured under UV light, or at an elevated temperature between 50° C. and 90° C. In some embodiments, the slurry comprises an initiator including without limitation Irgacure initiator, AIBN, and any other initiator mentioned above. In some embodiments, the slurry comprises an additive such as plasticizer as disclosed herein. In some embodiments, the slurry comprises an electrolyte salt.

In some embodiments, the method further includes transferring the slurry to a mold or coating the slurry on a surface prior to curing the slurry.

Some crosslinkers, electrolyte salts, additives and other materials as described in WO 2020096632 A1 and US application publication no. 20200144665 A1 and 20200144667 A1 are incorporated herein by reference in its entirety.

The following examples are intended to illustrate certain embodiments of the present disclosure, but do not exemplify the full scope of the disclosure.

Cycling performance: A pouch cell battery with a cathode, an anode, a separator, and an electrolyte was discharged and charged between various voltage ranges at room temperature using a Neware tester with various current rates. Cycle life is determined by the number of cycles for the battery cell to reach 80% of its original capacity (capacity retention).

### Example 1

Mixtures for synthesizing polymer electrolytes are obtained by mixing a crosslinker selected from Table 1 (1.5 wt %), 3.5 M lithium bis(fluorosulfonyl)imide (LiFSI), and an additive (0.1 wt %-1.0 wt %) selected from the group consisting of LiBF₄, LiPF₆, lithium fluorophosphate (Li₂PO₃F₂), lithium difluorophosphate (Li₂PO₂F₂), lithium difluoro(bisoxalato)phosphate (LiC₄PO₈F₂), and lithium tetrafluoro oxalato phosphate (LiC₂PO₄F₄), lithium fluoroalkyl-phosphates (Li[PFₓ(C_{y}F_{2y+1-z})₆₋ₓ]) (1≤x≤5, 1≤y≤8, and 0≤z≤2y−1), lithium difluoro(oxalato)borate (Li[BF₂(C₂O₄)], LiDFOB) and a combination thereof.

The mixtures for synthesizing polymer electrolytes are assembled in a pouch cell with Li as anode, and NMC811 as cathode, and the as-assembled cell is thermally cured at 60° C. for 1 to 2 hours. The solid-state polymer electrolyte (control with no additive) is also assembled into a pouch cell. The cycling test is performed with a Neware cycling tester. The charge/discharge voltage window is from 2.8 V to 4.25 V. The battery is cycled at a current rate of 0.33C for the charge and current rate of 0.5C for the discharge. The cycle number at capacity retention of 80% is measured for each of the mixtures with an additive and the base control mixture without the additive.

TABLE 1
Crosslinkers with 3 or more polymerizable terminals

| Crosslinker | Structure |
|---|---|
| tetraallyl silane, TAS | 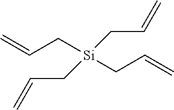 |
| 2,4,6,8-tetramethyl-2,4,6,8- tetravinylcyclotetrasiloxane | 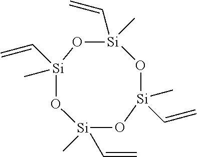 [SMILES: C=C[Si]1(C)O[Si](C)(C=C)O[Si](C)(C=C)O[Si](C)(C=C)O1] |
| Triethoxyvinylsilane | 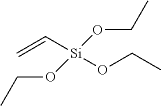 |
| allyltriethoxysilane | 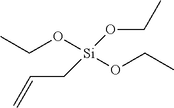 |
| pentaerythritol tetraacrylate | 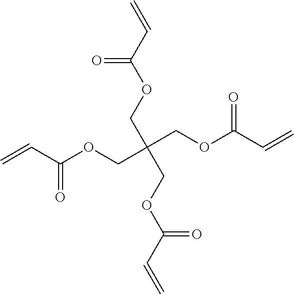 [SMILES: C=CC(=O)OCC(COC(=O)C=C)(COC(=O)C=C)COC(=O)C=C] |
| pentaerythritol tetramethacrylate | 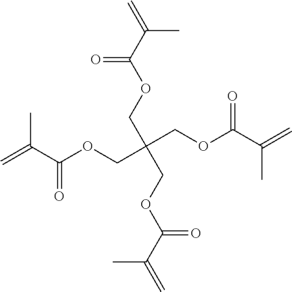 [SMILES: C=C(C)C(=O)OCC(COC(=O)C(=C)C)(COC(=O)C(=C)C)COC(=O)C(=C)C] |
| tris[2-(acryloyloxy)ethyl] isocyanurate, TAEI | 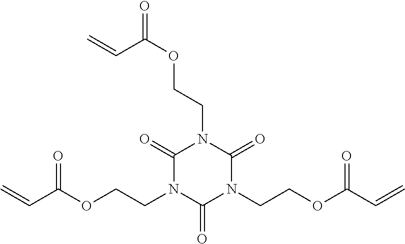 [SMILES: C=CC(=O)OCCn1c(=O)n(CCOC(=O)C=C)c(=O)n(CCOC(=O)C=C)c1=O] |
| di(trimethylolpropane) tetraacrylate (Di-TMPTA) | 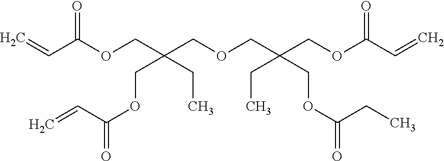 [SMILES: C=CC(=O)OCC(CC)(COCC(CC)(COC(=O)C=C)COC(=O)CC)COC(=O)C=C] |
| Trimethylolpropane propoxylate triacrylate | 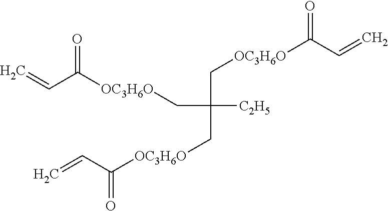 |
| Trimethylolpropane trimethacrylate | 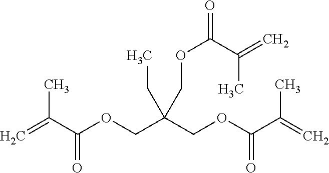 [SMILES: C=C(C)C(=O)OCC(CC)(COC(=O)C(=C)C)COC(=O)C(=C)C] |
| Pentaerythritol triacrylate | 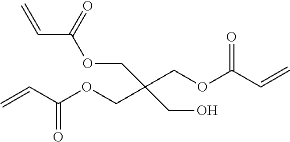 [SMILES: C=CC(=O)OCC(CO)(COC(=O)C=C)COC(=O)C=C] |
| Dipentaerythritol hexaacrylate | 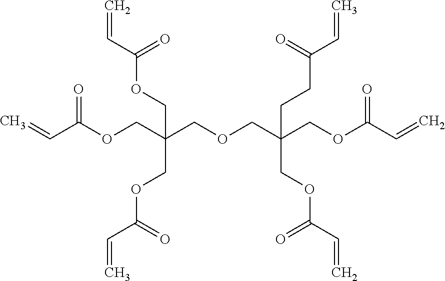 [SMILES: C=CC(=O)CCC(COCC(COC(=O)C=C)(COC(=O)C=C)COC(=O)C=C)(COC(=O)C=C)COC(=O)C=C] |
| Pentaerythritol tetrakis(3- mercaptopropionate) | 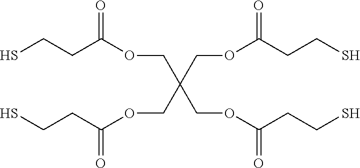 [SMILES: O=C(CCS)OCC(COC(=O)CCS)(COC(=O)CCS)COC(=O)CCS] |
| Trimethylolpropane tris(3- mercaptopropionate) | 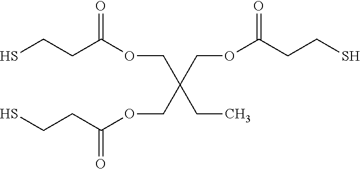 [SMILES: CCC(COC(=O)CCS)(COC(=O)CCS)COC(=O)CCS] |

The inclusion of the additive increases the cycle number at a capacity retention of 80%. The presence of the additive can increase the number of cycles at a capacity retention at 80% compared to the number of cycles at a capacity retention at 80% by at least 4%, at least 5%, at least 10%, at least 15%, at least 17%, or at least 20%.

### ASPECTS

In a first aspect, a polymer electrolyte comprises: a) an electrolyte salt; b) an additive; and c) a crosslinked polymer with a heterogeneous polymer network obtained from a crosslinking reaction of a mixture comprising the electrolyte salt, the additive and one or more crosslinkers, wherein at least one crosslinker has three or more polymerizable terminals; wherein the additive comprises element F and at least one of element B or P, and wherein the additive is different from the electrolyte salt.

In a second aspect according to the first aspect, the additive comprises F—B, F—P, F—P=O, F—P—O, or a combination thereof.

In a third aspect according to any of the preceding aspects, the additive is selected from the group consisting of LiBF₄, LiPF₆, lithium fluorophosphate (Li₂PO₃F₂), lithium difluorophosphate (Li₂PO₂F₂), lithium difluoro(bisoxalato)phosphate (LiC₄PO₈F₂), and lithium tetrafluoro oxalato phosphate (LiC₂PO₄F₄), lithium fluoroalkyl-phosphates (Li[PFₓ(C_{y}F_{2y+1-z})₆₋ₓ]) (1≤x≤5, 1≤y≤8, and 0≤z≤2y−1), lithium difluoro(oxalato)borate (Li[BF₂(C₂O₄)], LiDFOB) and a combination thereof.

In a fourth aspect according to any of the preceding aspects, the additive has a concentration in a range from 0.01 wt % to 5 wt % in the polymer electrolyte.

In a fifth aspect according to any of the preceding aspects, the electrolyte salt has a concentration in a range from 10 wt % to 90 wt % in the polymer electrolyte.

In a sixth aspect according to any of the preceding aspects, the crosslinker with three or more polymerizable terminals has a formula selected from the group consisting of:

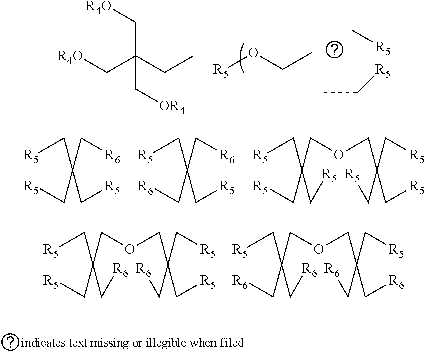

wherein R₄ and R₅ are independently selected from the group consisting of:

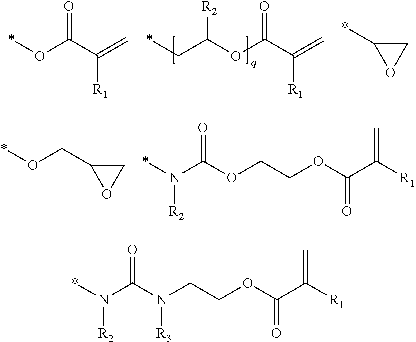

wherein R₁, R₂, R₃, and R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.

In a seventh aspect according to the sixth aspect, the crosslinker with three or more polymerizable terminals has a formula selected from the group consisting of:

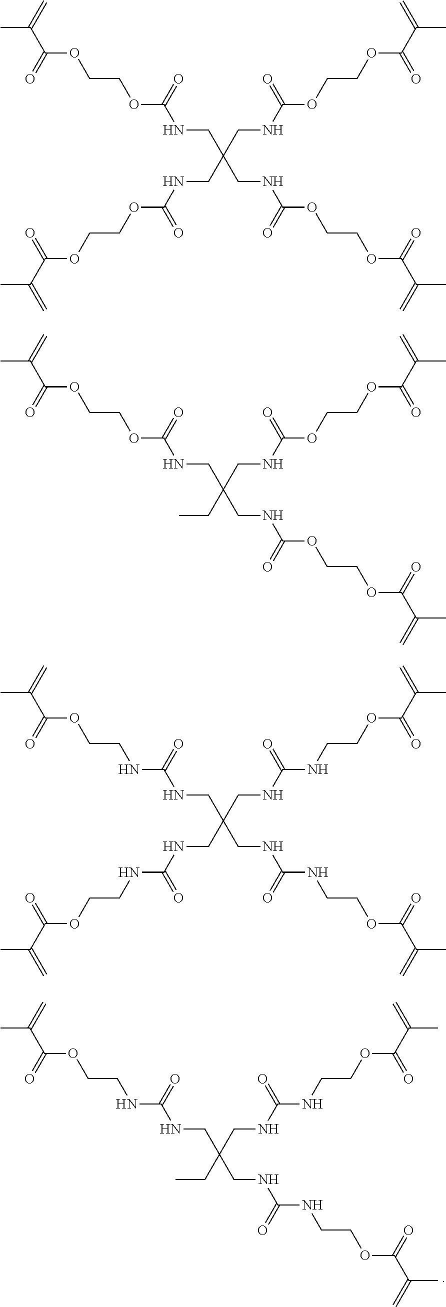

In an eighth aspect according to any of the preceding aspects, the crosslinked polymer is not over-crosslinked.

In a ninth aspect according to any of the preceding aspects, the one or more crosslinkers have a concentration in a range from 0.1 wt % to 20 wt % in the mixture.

In a tenth aspect according to any of the preceding aspects, the crosslinker with three or more polymerizable terminals has a concentration in a range from 0.1 wt % to 10 wt % in the mixture.

In an eleventh aspect according to any of the preceding aspects, at least one of the one or more crosslinkers has an electron-donating group, which promotes ion transport in the electrolyte.

In a twelfth aspect according to the eleventh aspect, the electron-donating group is an amide.

In a thirteenth aspect according to any of the preceding aspects, the crosslinked polymer is free of poly (ethylene oxide) chain.

In a fourteenth aspect according to any of the preceding aspects, the electrolyte salt comprises a lithium salt selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium nitrate(LiNO₃), lithium fluoroalkyl-phosphates (Li[PFₓ(C_{y}F_{2y+1-z})₆₋ₓ]) (1≤x≤5, 1≤y≤8, and 0≤z≤2y−1), lithium bis(perfluoroethysulfonyl)imide (LiBETI), lithium bis(trifluoromethanesulphonyl) imide, lithium bis(fluorosulphonyl)imide, lithium trifluoromethanesulfonimide (LiTFSI), lithium bis(fluorosulfonyl)imide (LiFSI), lithium difluoro(oxalato)borate (LiDFOB), LiC(CF₃SO₂)₃, LIF, LiCl, LiBr, LiI, Li₂SO₄, Li₃PO₄, Li₂CO₃, LiOH, lithium acetate, lithium trifluoromethyl acetate, lithium oxalate, lithium fluorophosphate (Li₂PO₃F), lithium difluorophosphate (Li₂PO₂F₂), lithium difluoro(bisoxalato)phosphate (LiC₄PO₈F₂), lithium tetrafluoro oxalato phosphate (LiC₂PO₄F₄) and a combination thereof.

In a fifteenth aspect, an electrochemical device comprises the polymer electrolyte of any of the preceding aspects.

In a sixteenth aspect according to the fifteenth aspect, the number of cycles at a capacity retention at 80% of the electrochemical device is at least 4% higher than that of the same electrochemical device not having the additive.

In a seventeenth aspect according to the fifteenth aspect, the number of cycles at a capacity retention at 80% of the electrochemical device is at least 10% higher than that of the same electrochemical device not having the additive.

In an eighteenth aspect, a method for preparing a polymer electrolyte comprises, a) mixing an electrolyte salt, an additive, and one or more crosslinkers to form a slurry, wherein the additive is different from the electrolyte salt, wherein the additive comprises element F and at least one of clement B or P, and wherein the one or more crosslinkers comprises at least one crosslinker with three or more polymerizable terminals; and b) curing the slurry, which converts the one or more crosslinkers into a crosslinked polymer with a heterogeneous polymer network, thus obtaining a polymer electrolyte comprising the crosslinked polymer with the heterogeneous polymer network.

In a nineteenth aspect according to the eighteenth aspect, the additive comprises F—B, F—P, F—P=O, F—P=O, or a combination thereof, wherein the additive has a concentration in a range from 0.01 wt % to 5.0 wt % in the slurry, and wherein the electrolyte salt has a concentration in a range from 10 wt % to 90 wt % in the slurry.

In a twentieth aspect according to the eighteenth or nineteenth aspect, the slurry is cured after applying the slurry onto a substrate or is in situ cured after assembling the slurry into a cell assembly comprising a cathode layer and an anode layer.

While several embodiments of the present disclosure have been described and illustrated hercin, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple clements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

We claim:

1. A polymer electrolyte comprising:
a) an electrolyte salt;
b) an additive; and
c) a crosslinked polymer with a heterogeneous polymer network obtained from a crosslinking reaction of a mixture comprising the electrolyte salt, the additive and one or more crosslinkers,
wherein at least one crosslinker has three or more polymerizable terminals;
wherein the additive comprises element F and at least one of element B or P, and
wherein the additive is different from the electrolyte salt.

2. The polymer electrolyte of claim 1, wherein the additive comprises F—B, F—P, F—P=O, F—P=O, or a combination thereof.

3. The polymer electrolyte of claim 1, wherein the additive is selected from the group consisting of LiBF₄, LiPF₆, lithium fluorophosphate (Li₂PO₃F₂), lithium difluorophosphate (Li₂PO₂F₂), lithium difluoro(bisoxalato)phosphate (LiC₄PO₈F₂), and lithium tetrafluoro oxalato phosphate (LiC₂PO₄F₄), lithium fluoroalkyl-phosphates (Li[PFₓ(C_{y}F_{2y+1-z})₆₋ₓ]) (1≤x≤5, 1≤y≤8, and 0≤z≤2y−1), lithium difluoro(oxalato)borate (Li[BF₂(C₂O₄)], LiDFOB) and a combination thereof.

4. The polymer electrolyte of claim 1, wherein the additive has a concentration in a range from 0.01 wt % to 5 wt % in the polymer electrolyte.

5. The polymer electrolyte of claim 1, wherein the electrolyte salt has a concentration in a range from 10 wt % to 90 wt % in the polymer electrolyte.

6. The polymer electrolyte of claim 1, wherein the crosslinker with three or more polymerizable terminals has a formula selected from the group consisting of: 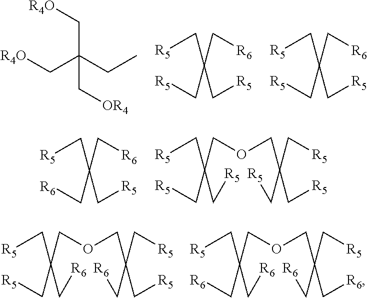
wherein R₄ and R₅ are independently selected from the group consisting of: 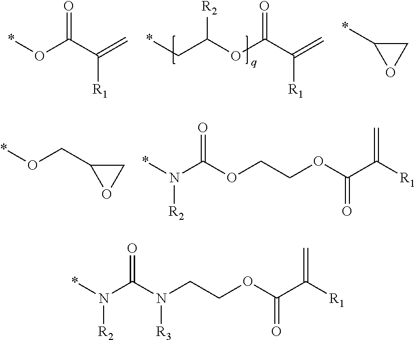
wherein R_{1,} R_{2,} R_{3,} and R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.

7. The polymer electrolyte of claim 6, wherein the crosslinker with three or more polymerizable terminals has a formula selected from the group consisting of:

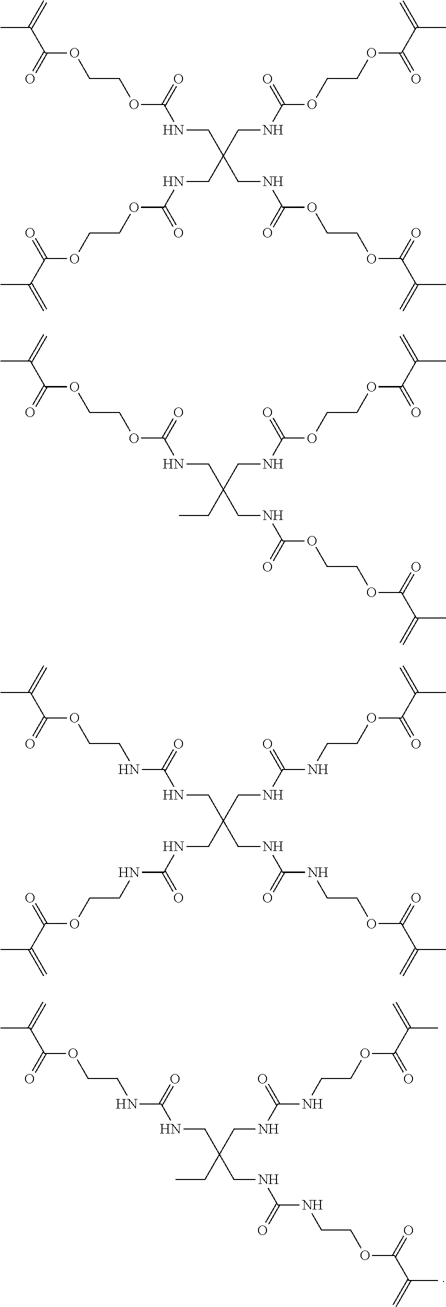

8. The polymer electrolyte of claim 1, wherein the crosslinked polymer is not over-crosslinked.

9. The polymer electrolyte of claim 1, wherein the one or more crosslinkers have a concentration in a range from 0.1 wt % to 20 wt % in the mixture.

10. The polymer electrolyte of claim 1, wherein the crosslinker with three or more polymerizable terminals has a concentration in a range from 0.1 wt % to 10 wt % in the mixture.

11. The polymer electrolyte of claim 1, wherein at least one of the one or more crosslinkers has an electron-donating group, which promotes ion transport in the electrolyte.

12. The polymer electrolyte of claim 11, wherein the electron-donating group is an amide.

13. The polymer electrolyte of claim 1, wherein the crosslinked polymer is free of poly (ethylene oxide) chain.

14. The polymer electrolyte of claim 1, wherein the electrolyte salt comprises a lithium salt selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium nitrate(LiNO₃), lithium fluoroalkyl-phosphates (Li[PFₓ(C_{y}F_{2y+1-z})₆₋ₓ]) (1≤x≤5, 1≤y≤8, and 0≤z≤2y−1), lithium bis(perfluoroethysulfonyl)imide (LiBETI), lithium bis(trifluoromethanesulphonyl) imide, lithium bis(fluorosulphonyl)imide, lithium trifluoromethanesulfonimide (LiTFSI), lithium bis(fluorosulfonyl)imide (LiFSI), lithium difluoro(oxalato)borate (LiDFOB), LiC(CF₃SO₂)₃, LiF, LiCl, LiBr, LiI, Li₂SO₄, Li₃PO₄, Li₂CO₃, LiOH, lithium acetate, lithium trifluoromethyl acetate, lithium oxalate, lithium fluorophosphate (Li₂PO₃F₂), lithium difluorophosphate (Li₂PO₃F), lithium difluoro(bisoxalato)phosphate (LiC₄PO₈F₂), lithium tetrafluoro oxalato phosphate (LiC₂PO₄F₄) and a combination thereof.

15. An electrochemical device, comprising the polymer electrolyte of claim 1.

16. The electrochemical device of claim 15, wherein the number of cycles at a capacity retention at 80% of the electrochemical device is at least 4% higher than that of the same electrochemical device not having the additive.

17. The electrochemical device of claim 15, wherein the number of cycles at a capacity retention at 80% of the electrochemical device is at least 10% higher than that of the same electrochemical device not having the additive.

18. A method for preparing a polymer electrolyte, comprising:

1. mixing an electrolyte salt, an additive, and one or more crosslinkers to form a slurry, wherein the additive is different from the electrolyte salt, wherein the additive comprises element F and at least one of element B or P, and wherein the one or more crosslinkers comprises at least one crosslinker with three or more polymerizable terminals; and

2. curing the slurry, which converts the one or more crosslinkers into a crosslinked polymer with a heterogeneous polymer network, thus obtaining a polymer electrolyte comprising the crosslinked polymer with the heterogeneous polymer network.

19. The method of claim 18, wherein the additive comprises F—B, F—P, F—P=O, F—P=O, or a combination thereof, wherein the additive has a concentration in a range from 0.01 wt % to 5.0 wt % in the slurry, and wherein the electrolyte salt has a concentration in a range from 10 wt % to 90 wt % in the slurry.

20. The method of claim 18, wherein the slurry is cured after applying the slurry onto a substrate or is in situ cured after assembling the slurry into a cell assembly comprising a cathode layer and an anode layer.
